(19) United States
(12) Patent Application Publication
(10) Pub. No.: US 2019/0057235 A1
(43) Pub. Date: Feb. 21, 2019

(54) BIOMETRIC IDENTIFICATION APPARATUS HAVING MULTIPLE ELECTRODES

(71) Applicant: SUPERC-TOUCH CORPORATION, New Taipei City (TW)

(72) Inventors: HSIANG-YU LEE, New Taipei City (TW); Shang CHIN, New Taipei City (TW); Ping-Tsun LIN, New Taipei City (TW); Chia-Hsun TU, New Taipei City (TW)

(21) Appl. No.: 15/682,535

(22) Filed: Aug. 21, 2017

(51) Int. Cl. G06K 9/00

(52) U.S. Cl. CPC G06K 9/0002; G06K 9/00053; G06K 9/00107; G06K 9/00087

(57) ABSTRACT

A biometric identification apparatus having multiple electrode layers includes a sensing electrode layer having a plurality of sensing electrodes, an enhancing electrode layer having at least one enhancing electrode and a capacitance-blocking electrode layer having at least one capacitance-blocking electrode. During sensing of biometric features of living beings skin, a fingerprint sensing circuit applies a capacitance exciting signal to a selected sensing electrode, applies an enhancing signal to at least one enhancing electrode to focus and enhance sensed electric field lines, and applies a capacitance-blocking signal to at least one capacitance-blocking electrode to eliminate influence of ambient stray capacitance to the selected sensing electrode.

### BACKGROUND OF THE INVENTION

### Field of the Invention

The present invention relates to a biometric identification apparatus, especially to a biometric identification apparatus having multiple electrodes.

### Description of Prior Art

Biometric identification technologies have rapid development due to the strong demand from electronic security applications and remote payment. The biometric identification technologies can be classified into fingerprint identification, iris identification and DNA identification and so on. For the considerations of efficiency, safety and non-invasiveness, the fingerprint identification becomes main stream technology. The fingerprint identification device can scan fingerprint image by optical scanning, thermal imaging or capacitive imaging. For cost, power-saving, reliability and security concerns, the capacitive fingerprint sensor becomes popular for biometric identification technology applied to portable electronic devices.

The conventional capacitive fingerprint sensors can be classified into swipe type and area type (pressing type), and the area type has better identification correctness, efficiency and convenience. However, the area type capacitive fingerprint sensor generally integrates the sensing electrodes and the sensing circuit into one integrated circuit (IC) because the sensed signals are minute and the background noise is huge in comparison with the minute sensed signals. In conventional area type technique, sealing epoxy is used to protect lead-out wires and package the fingerprint sensing IC. However, tens of micro-meters distance is present between the sensing electrode and user finger due to the sealing epoxy. To reduce the impact of the sealing epoxy, expensive sapphire material with high dielectric coefficient is used for protect the fingerprint sensing IC. Nevertheless, this is still disadvantageous for device integration due to the extra distance between sensing electrode and user finger. A common approach is to drill hole on the protection glass and then inlay the fingerprint sensing IC into the hole. As a result, the material cost and package cost is high while the yield, lifetime and durability are influenced. There are development trends to enhance the sensing ability and signal-to-noise ratio and then increase the effective sensing distance (distance between the sensing electrode and user finger) and to simplify the packing structure for the fingerprint sensing IC. In a word, there is much room for further improvement of the fingerprint identification apparatus in aspects of cost down, lifetime and durability.

The present invention is aimed to provide a biometric identification apparatus with low cost, high sensing sensibility, high signal-to-noise ratio and large effective sensing distance. The technology provided by the present invention can be applied to IC-type fingerprint identification apparatus or glass type (or polymer thin film type) fingerprint identification apparatus. With at least one enhancing electrode layer and at least one capacitance-blocking electrode layer, the electric field lines can be more focused toward user finger, the noise or interference from the ambient stray capacitance can be blocked or prevented to enhance the stability of sensed signal.

### SUMMARY OF THE INVENTION

The object of the present invention is to overcome disadvantages mentioned above by providing a biometric identification apparatus having multiple electrode layers.

Accordingly, the present invention provides a biometric identification apparatus having multiple electrode layers, comprising: a substrate; a sensing electrode layer having a plurality of sensing electrodes, the sensing electrode layer having a sensing face and an non-sensing face opposite to the sensing face; an enhancing electrode layer arranged on one side of the non-sensing face of the sensing electrode layer and having at least one enhancing electrode; N capacitance-blocking electrode layer arranged on one side of the enhancing electrode layer opposite to the sensing electrode layer, wherein N is a positive integer larger than or equal to one, each of the capacitance-blocking electrode layers has at least one capacitance-blocking electrode; wherein the enhancing electrode is corresponding to at least one of the sensing electrodes, the capacitance-blocking electrode is corresponding to at least one of the sensing electrodes, wherein the substrate is arranged on one side of the sensing electrode layer or one side of the capacitance-blocking electrode layer.

Accordingly, the present invention provides a biometric identification apparatus, comprising: a substrate; at least two electrode layer comprising a sensing electrode layer and an enhancing electrode layer, the sensing electrode layer having a sensing face on one side thereof and the enhancing electrode layer arranged on another side of the sensing electrode layer opposite to the sensing face, the sensing electrode layer having a plurality of sensing electrodes arranged in rows and columns, the enhancing electrode layer having a plurality of enhancing electrodes, each of the enhancing electrodes being corresponding to at least one of the sensing electrodes; a plurality of transistor switches, each of the sensing electrodes being corresponding to and electrically connected to at least two transistor switches; a plurality of connection wires comprising connection wires along a first direction and connection wires along a second direction, wherein each row of the sensing electrodes are corresponding to the connection wires along the first direction, and each of the connection wires along the first direction is connected to a node of the transistor switch corresponding to the row of the sensing electrodes; wherein each column of the sensing electrodes are corresponding to the connection wires along the second direction, and each of the connection wires along the second direction is connected to a node of the transistor switch corresponding to the column of the sensing electrodes.

The present invention at least achieve following advantages: by providing at least one enhancing electrode layer and at least one capacitance-blocking electrode layer, the electric field lines can be more focused toward user finger, the noise or interference from the ambient stray capacitance can be blocked or prevented to enhance the stability of sensed signal.

### BRIEF DESCRIPTION OF DRAWING

One or more embodiments of the present disclosure are illustrated by way of example and not limitation in the figures of the accompanying drawings, in which like references indicate similar elements. These drawings are not necessarily drawn to scale.

FIGS. 1A-1C show stack diagrams of the biometric identification apparatus having multiple electrode layers according to different embodiments of the present invention.

FIGS. 2A-2C show stack diagrams of the biometric identification apparatus having multiple electrode layers according to different embodiments of the present invention.

FIGS. 3A and 3B show signal generation for the biometric identification apparatus according to different embodiments of the present invention.

FIGS. 4A and 4B show signal generation for the biometric identification apparatus according to different embodiments of the present invention.

FIGS. 5A-5B show signal application manner for biometric identification apparatus according to different embodiments of the present invention.

FIGS. 6A-6C show the distribution of electrodes in the biometric identification apparatus according to different embodiments of the present invention.

FIGS. 7A-7C show signal generation for biometric identification apparatus 100 to different embodiments of the present invention.

FIG. 8 is a detailed scheme diagram of the biometric identification apparatus according to another embodiment of the present invention.

FIG. 9 is a detailed scheme diagram of the biometric identification apparatus according to still another embodiment of the present invention.

FIG. 10 is a detailed scheme diagram of the biometric identification apparatus according to still another embodiment of the present invention.

FIGS. 11A-11B show the control signal and transistor switch for the biometric identification apparatus according to different embodiments of the present invention.

FIG. 12 shows the circuit diagram of the self-capacitance sensing circuit according to an embodiment of the present invention.

### DETAILED DESCRIPTION OF THE INVENTION

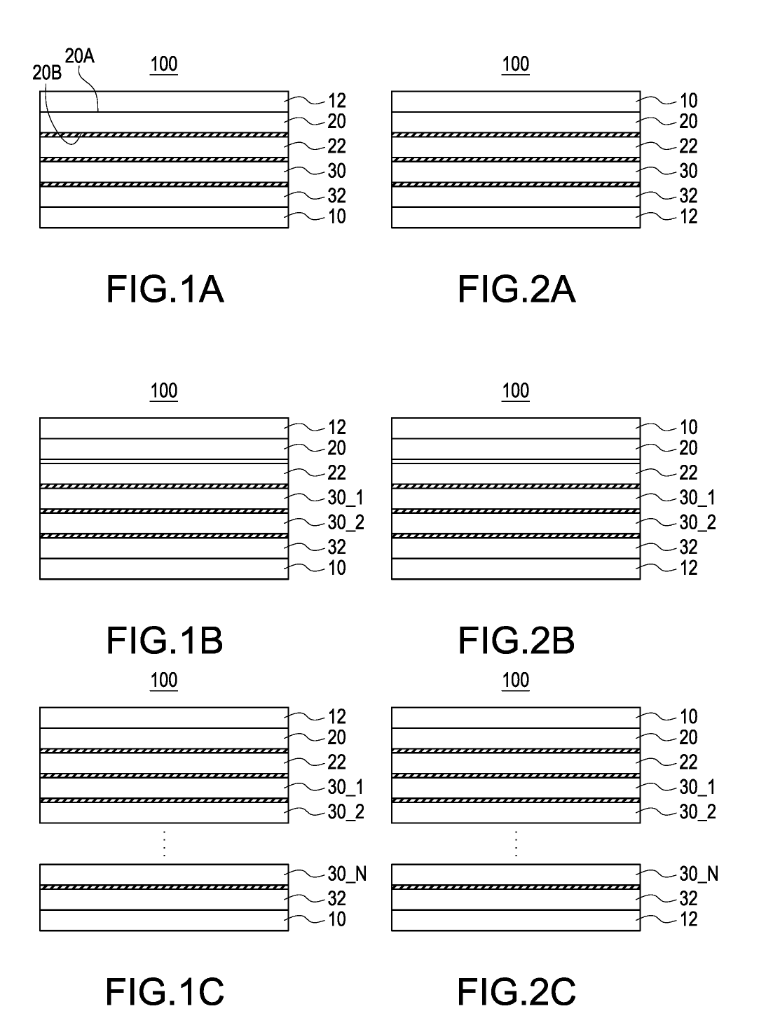

FIG. 1A is stack diagram of the biometric identification apparatus 100 having multiple electrode layers according to an embodiment of the present invention. The biometric identification apparatus 100 includes, from top to bottom, a protection layer 12, a sensing electrode layer 20, an enhancing electrode layer 22, a capacitance-blocking electrode layer 30, a circuit layer 32 and a substrate 10. Besides, insulating layers (not labelled and highlighted with shaded pattern in FIG. 1A) are arranged between two adjacent layers of the sensing electrode layer 20, the enhancing electrode layer 22, the capacitance-blocking electrode layer 30, and the circuit layer 32 for providing insulation between two adjacent layers. However, insulating layers are not major features of the present invention and detailed description thereof is omitted here for brevity. As shown in FIG. 1A, the sensing electrode layer 20 includes a sensing face 20A and a non-sensing face 20B and user finger is closer to the sensing face 20A such that the biometric identification apparatus 100 may sense biometric features (such as fingerprint) of living beings skin such as user skin) when user finger operates on the sensing face 20A.

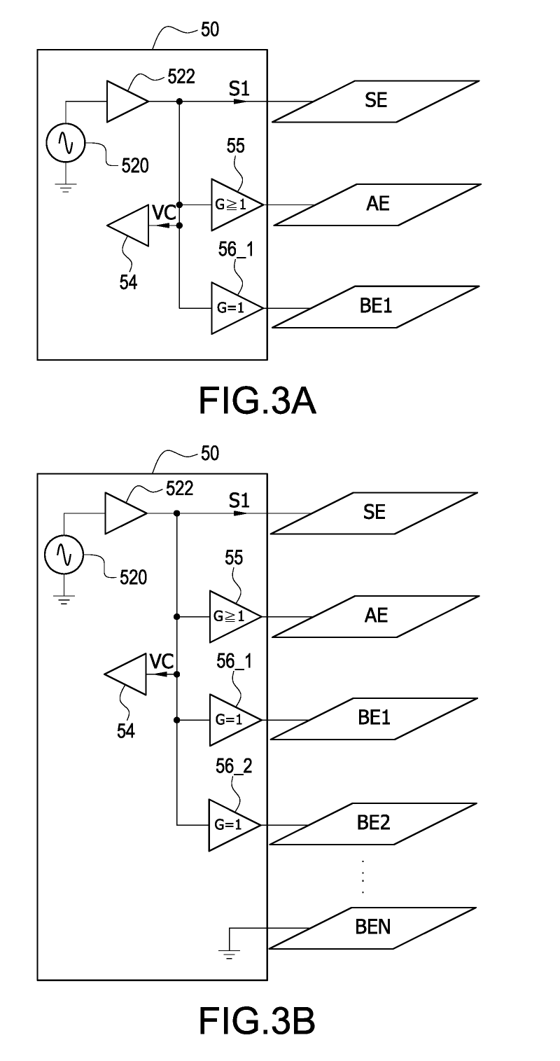

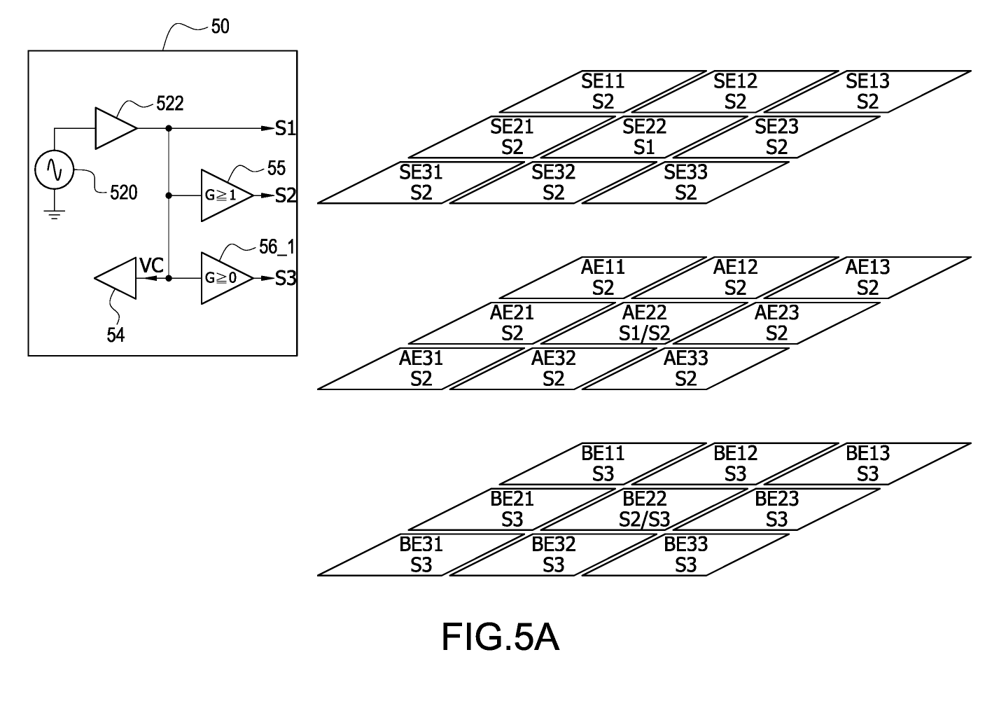

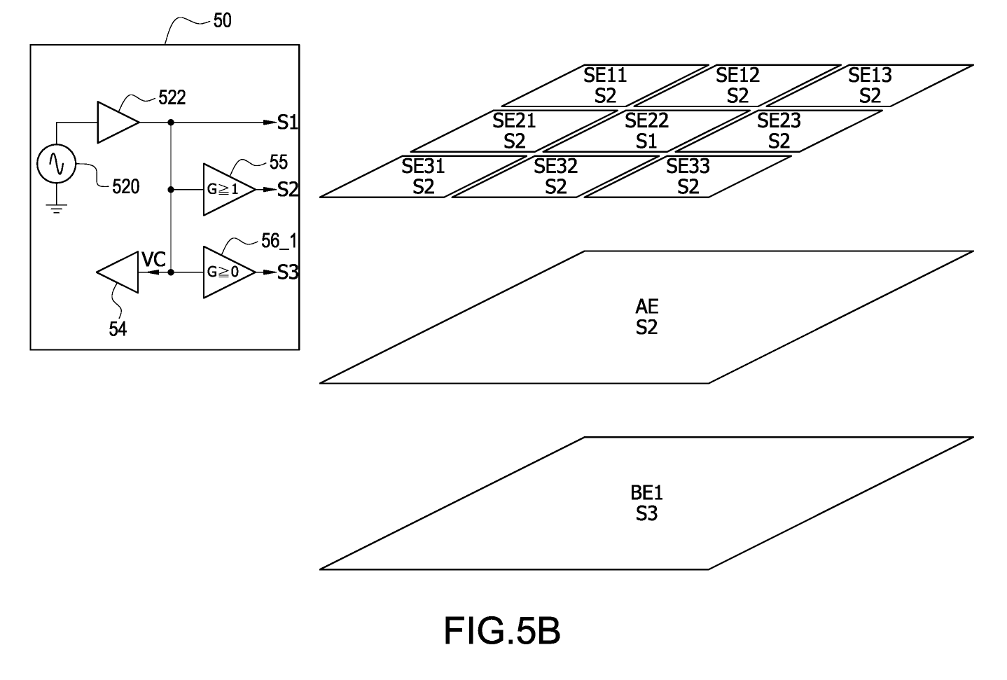

FIG. 3A shows signal generation for the biometric identification apparatus 100 in FIG. 1A, and FIG. 5A shows signal application manner for biometric identification apparatus 100 in FIG. 1A. As shown in FIG. 5A, the sensing electrode layer 20 includes a plurality of sensing electrodes SE11-SE33, the enhancing electrode layer 22 includes at least one enhancing electrode (such as a plurality of enhancing electrodes AE11-AE33 in this figure), and the capacitance-blocking electrode layer 30 includes at least one capacitance-blocking electrode (such as a plurality of capacitance-blocking electrodes BE11-BE33 in this figure). Besides, each of the enhancing electrodes AE is corresponding to at least one sensing electrode SE, each of the capacitance-blocking electrodes BE is corresponding to at least one sensing electrode SE.

With reference to FIG. 3A, the biometric identification apparatus 100 includes a fingerprint sensing circuit (such as a fingerprint sensing circuit including a self-capacitance sensing circuit 50) electrically connected to the sensing electrodes of the sensing electrode layer 20, the enhancing electrode of the enhancing electrode layer 22 and capacitance-blocking electrode of the capacitance-blocking electrode layer 30. The self-capacitance sensing circuit 50 includes a signal source 520, a driving unit 522, an enhancing amplifier 55, a first blocking amplifier 56_1, and a capacitance measuring circuit 54. The self-capacitance sensing circuit 50 may be arranged on the circuit layer 32 and electrically connected to the sensing electrode layer 20, the enhancing electrode layer 22 and the capacitance-blocking electrode layer 30 through a plurality of connection wires (will be described in more detail later). Alternatively, the self-capacitance sensing circuit 50 may be arranged on another substrate different with the substrate 10 and electrically connected to the substrate 10 through a flexible circuit board.

The signal source 520 generates a capacitance exciting signal Si through the driving unit 522 and then sequentially or randomly applies the capacitance exciting signal Si to at least one selected sensing electrode SE (such as the sensing electrode SE22 shown in FIG. 5A). Moreover, the capacitance exciting signal S1 is non-inverting amplified by the enhancing amplifier 55 (with gain 1) to form an enhancing signal S2, which is applied to at least one enhancing electrode AE22 corresponding to the selected sensing electrode SE22. Besides, the enhancing signal S2 may also be applied to other sensing electrodes surrounding the selected sensing electrode SE22. Moreover, the capacitance exciting signal S1 is non-inverting amplified by the first blocking amplifier 56_1 (with gain≥0) to form a capacitance blocking signal S3, which is applied to at least one first capacitance-blocking electrode BE22 corresponding to the selected sensing electrode SE22. As shown in FIG. 5A, another possible signal application manner is to apply the capacitance exciting signal Si to at least one enhancing electrode AE22 corresponding to the selected sensing electrode SE22, while the enhancing signal S2 is applied to other enhancing electrodes except the enhancing electrode AE22 (for example the other enhancing electrodes surrounding the enhancing electrode AE22) and the capacitance blocking signal S3 is also applied to the other capacitance-blocking electrodes (for example the other first capacitance blocking electrodes surrounding the first capacitance-blocking electrode BE22).

By applying the enhancing signal S2 (with amplitude larger than or equal to the amplitude of the capacitance exciting signal S1) to the corresponding enhancing electrode AE22, or applying the capacitance exciting signal Si to the corresponding enhancing electrode AE22, the electric field lines can be more focused toward user finger. Besides, by applying the capacitance blocking signal S3 (with phase same as the phase of the capacitance exciting signal Si or being a zero voltage signal) to the corresponding first capacitance-blocking electrode BE22, the noise or interference from the circuit layer 32 can be blocked or prevented.

FIG. 1B shows a stack diagram of the biometric identification apparatus 100 according to another embodiment of the present invention. This embodiment in FIG. 1B is similar to that shown in FIG. 1A; however, the biometric identification apparatus 100 has two capacitance-blocking electrode layers, namely, the first capacitance-blocking electrode layer 30_1 and the second capacitance-blocking electrode layer 30_2. FIG. 1C shows a stack diagram of the biometric identification apparatus 100 according to still another embodiment of the present invention. This embodiment in FIG. 1C is similar to that shown in FIG. 1A, however, the biometric identification apparatus 100 has N capacitance-blocking electrode layers (N is an positive integer and N≥1), namely, the first capacitance-blocking electrode layer 30_1, the second capacitance-blocking electrode layer 30_2 . . . the Nth capacitance-blocking electrode layer 30_N.

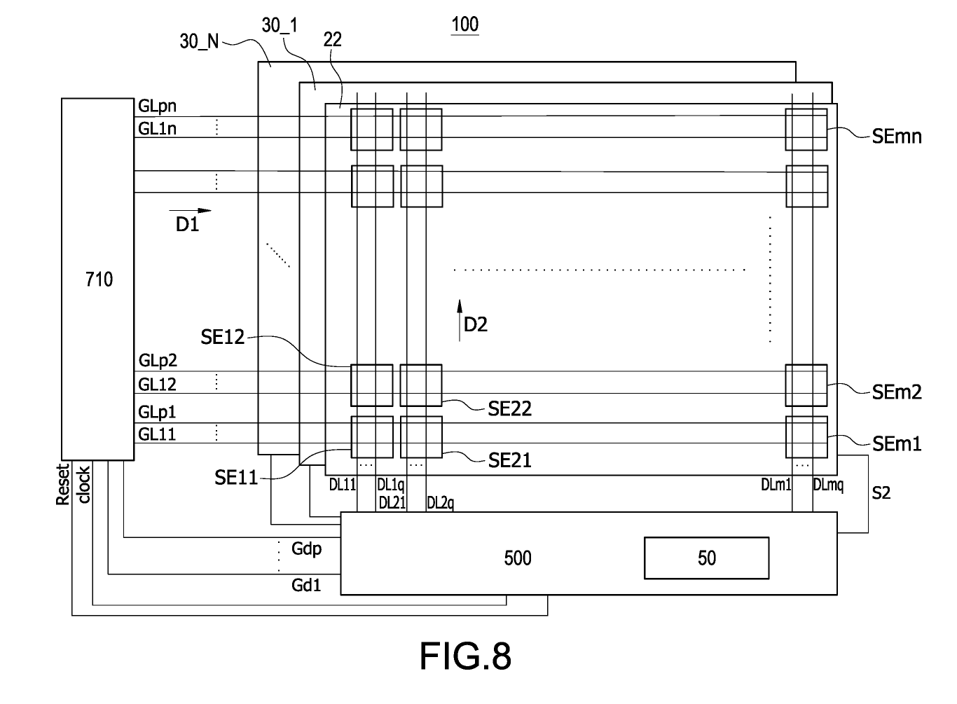

FIG. 2A shows a stack diagram of the biometric identification apparatus 100 according to still another embodiment of the present invention. This embodiment in FIG. 2A is similar to that shown in FIG. 1A; however, the locations of the substrate 10 and the protection layer 12 exchange. FIG. 2B shows a stack diagram of the biometric identification apparatus 100 according to still another embodiment of the present invention. This embodiment in FIG. 2B is similar to that shown in FIG. 1B; however, the locations of the substrate 10 and the protection layer 12 exchange. FIG. 2C shows a stack diagram of the biometric identification apparatus 100 according to still another embodiment of the present invention. This embodiment in FIG. 2C is similar to that shown in FIG. 1C; however, the locations of the substrate 10 and the protection layer 12 exchange. In the embodiments shown in FIGS. 1A-2C, the substrate 10 may be an integrated circuit substrate and includes fingerprint sensing circuit having the self-capacitance sensing circuit 50 or integrated circuit (such as the fingerprint sensing integrated circuit 500 shown in FIG. 8) arranged on the substrate 10. Alternatively, the substrate 10 may be a glass substrate, a sapphire substrate, a ceramic substrate or a metallic substrate. The biometric identification apparatus 100 further includes an integrated circuit (such as the fingerprint sensing integrated circuit 500 shown in FIG. 8), and the integrated circuit is bonded to, adhered to or soldered to the substrate 10. Alternatively, the integrated circuit may be arranged on a flexible circuit board and electrically connected to the substrate 10 through the flexible circuit board.

FIG. 3B shows signal generation for the biometric identification apparatus 100 in FIG. 1C. The embodiment shown in FIG. 3B is similar to that shown in FIG. 3A, however, the self-capacitance sensing circuit 50 further includes a second blocking amplifier 56_2 . . . an (N-1)th blocking amplifier 56 N-1 respectively coupled to the second capacitance-blocking electrode BE2 . . . the (N-1) capacitance-blocking electrode BE(N-1) while the Nth capacitance-blocking electrode BEN is grounded.

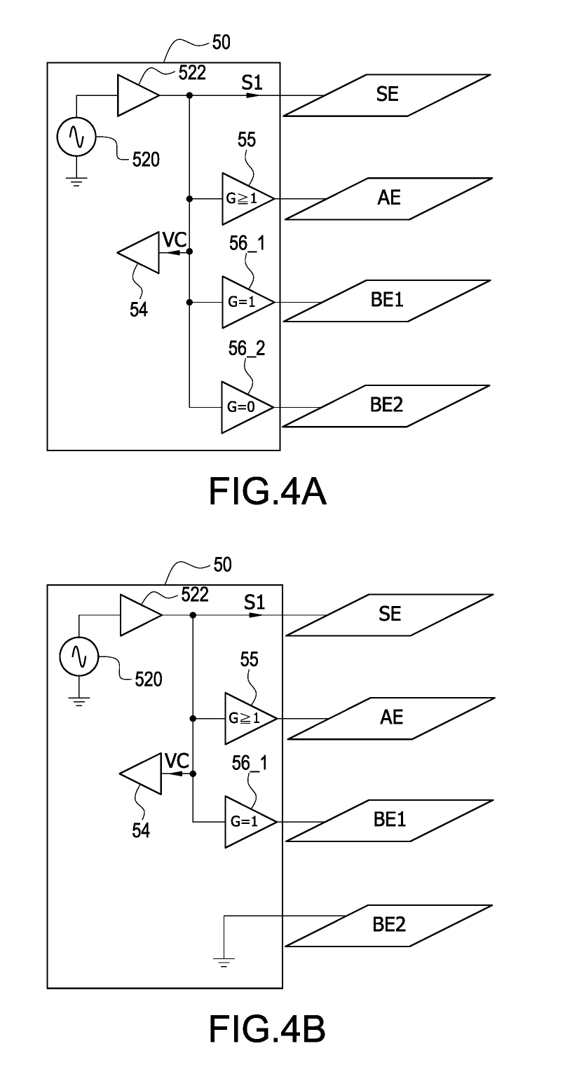

FIG. 4A shows signal generation for the biometric identification apparatus 100 in FIG. 1B. The embodiment shown in FIG. 4A is similar to that shown in FIG. 3A, however, the self-capacitance sensing circuit 50 further includes a second blocking amplifier 56_2 (with gain of zero) and the second blocking amplifier 56_2 generates a zero voltage signal applied to the second capacitance-blocking electrode BE2. FIG. 4B shows signal generation for the biometric identification apparatus 100 in FIG. 1B. The embodiment shown in FIG. 4B is similar to that shown in FIG. 4A; however, the second capacitance-blocking electrode BE2 is directly connected to ground. The electric energy can be saved if the second capacitance-blocking electrode BE2 is directly connected to ground.

FIG. 5B shows signal application manner for biometric identification apparatus 100. The embodiment shown in FIG. 5B is similar to that shown in FIG. 5A; however, the biometric identification apparatus 100 shown in FIG. 5B has only one enhancing electrode AE on the enhancing electrode layer 22 and only one capacitance-blocking electrode (namely, the first capacitance-blocking electrode BE1) on the capacitance-blocking electrode layer 30. The enhancing signal S2 of the self-capacitance sensing circuit 50 is applied to the enhancing electrode AE and the capacitance blocking signal S3 of the self-capacitance sensing circuit 50 is also applied to the capacitance-blocking electrodes BEL Similarly, the electric field lines can be more focused toward user finger, the noise or interference from the circuit layer 32 can be blocked or prevented.

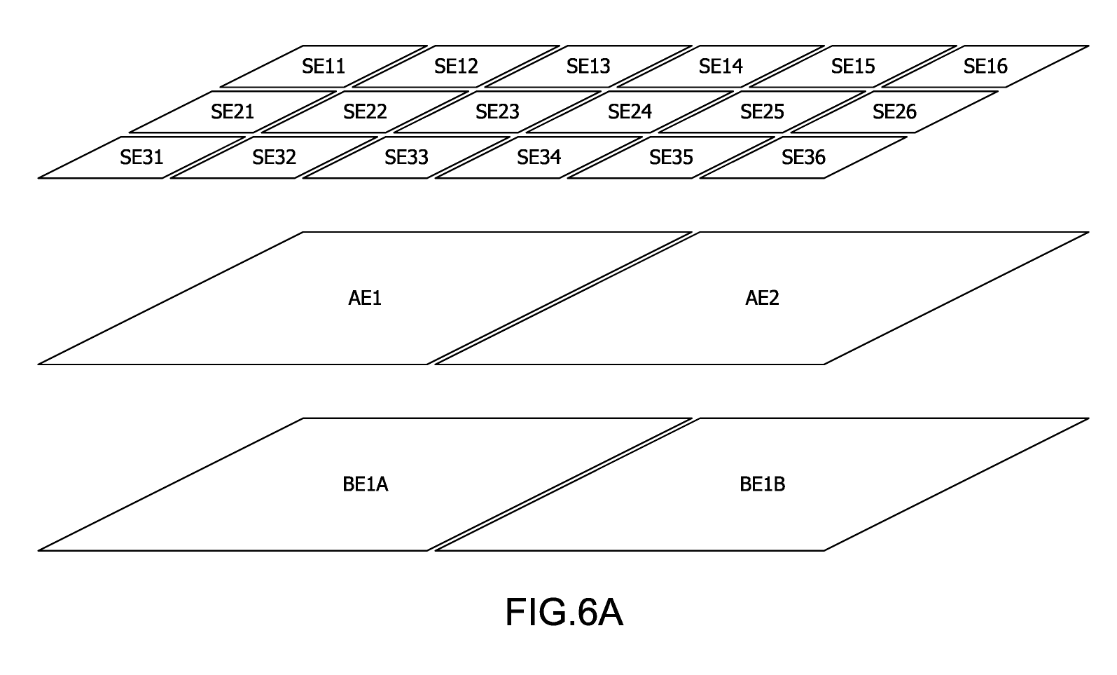

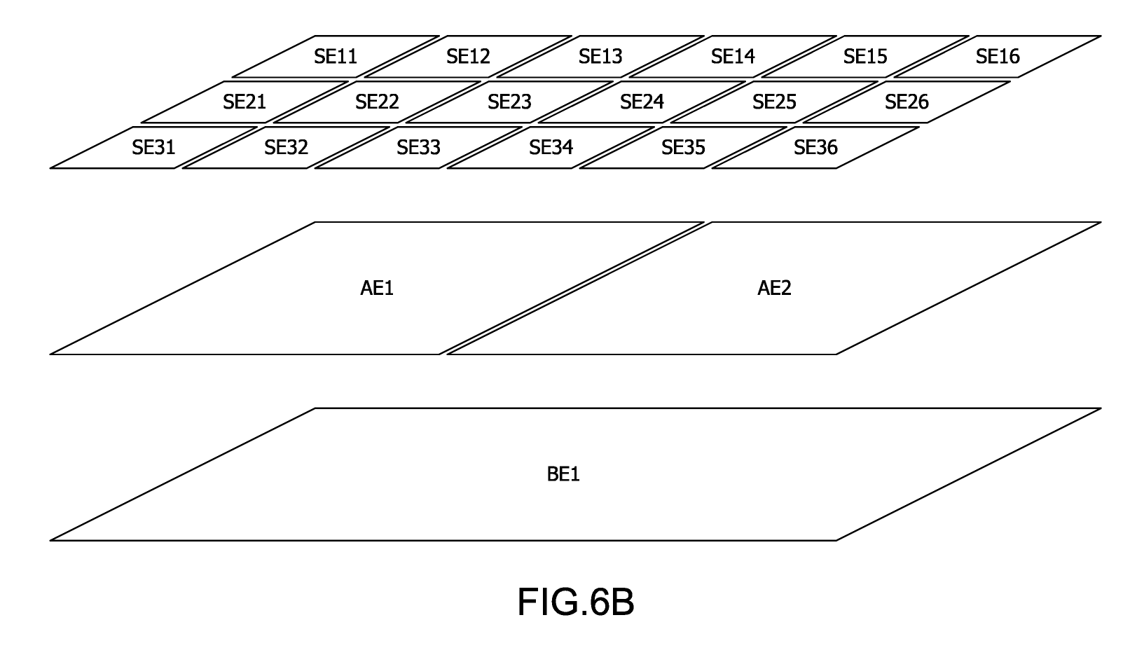

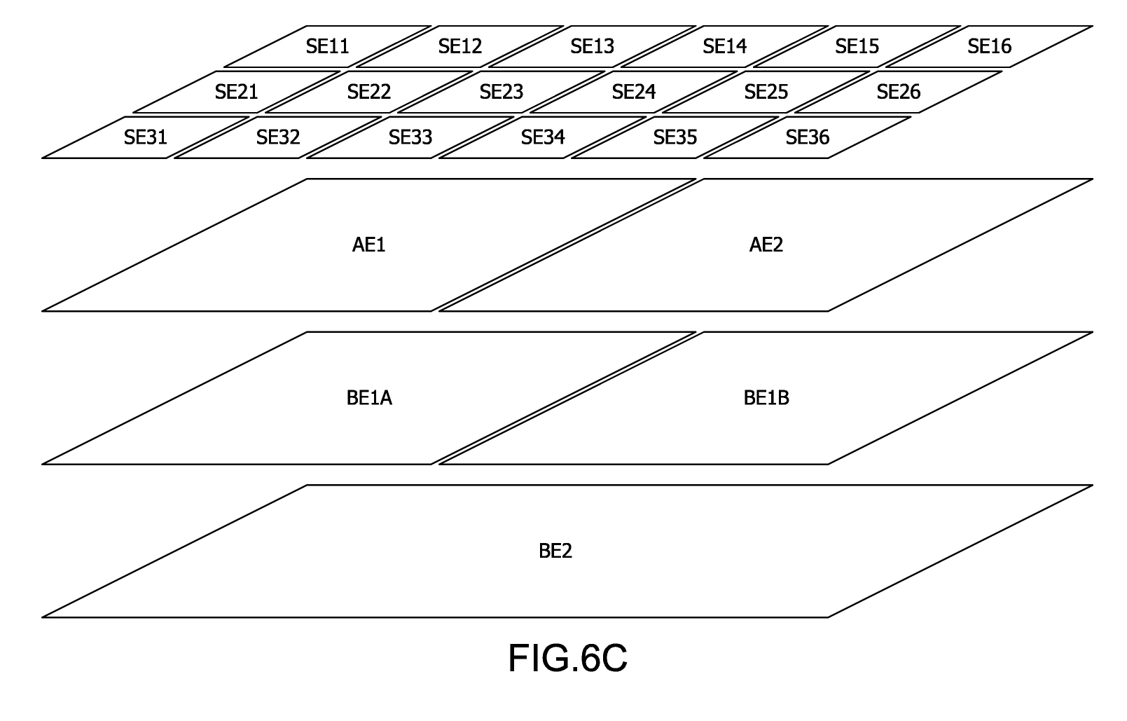

FIG. 6A shows the distribution of electrodes in the biometric identification apparatus 100 according to another embodiment of the present invention. As shown in this figure, the enhancing electrode layer 22 has two enhancing electrodes AE1, AE2. The sensing electrodes SE11-SE13, SE21-SE23, SE31-SE33 are corresponding to the enhancing electrode AE1, while the sensing electrodes SE14-SE16, SE24-SE26, SE34-SE36 are corresponding to the enhancing electrode AE2. Moreover, the first capacitance-blocking electrode layer 30_1 has two capacitance-blocking electrodes BE1A, BE1B. The sensing electrodes SE11-SE13, SE21-SE23, SE31-SE33 are corresponding to the capacitance-blocking electrode BE1A, while the sensing electrodes SE14-SE16, SE24-SE26, SE34-SE36 are corresponding to the capacitance-blocking electrode BE1B.

FIG. 6B shows the distribution of electrodes in the biometric identification apparatus 100 according to still another embodiment of the present invention. As shown in this figure, the enhancing electrode layer 22 has two enhancing electrodes AE1, AE2. The sensing electrodes SE11-SE13, SE21-SE23, SE31-SE33 are corresponding to the enhancing electrode AE1, while the sensing electrodes SE14-SE16, SE24-SE26, SE34-SE36 are corresponding to the enhancing electrode AE2. Moreover, the first capacitance-blocking electrode layer 30_1 has only one capacitance-blocking electrode BE1 and corresponding to all of the sensing electrodes SE11-SE36.

FIG. 6C shows the distribution of electrodes in the biometric identification apparatus 100 according to still another embodiment of the present invention. As shown in this figure, the enhancing electrode layer 22 has two enhancing electrodes AE1, AE2. The sensing electrodes SE11-SE13, SE21-SE23, SE31-SE33 are corresponding to the enhancing electrode AE1, while the sensing electrodes SE14-SE16, SE24-SE26, SE34-SE36 are corresponding to the enhancing electrode AE2. Moreover, the first capacitance-blocking electrode layer 30_1 has two capacitance-blocking electrodes BE1A, BE1B. The sensing electrodes SE11-SE13, SE21-SE23, SE31-SE33 are corresponding to the capacitance-blocking electrode BE1A, while the sensing electrodes SE14-SE16, SE24-SE26, SE34-SE36 are corresponding to the capacitance-blocking electrode BE1B. Besides, the second capacitance-blocking electrode layer 30_2 has only one capacitance-blocking electrode BE2 and corresponding to all of the sensing electrodes SE11-SE36.

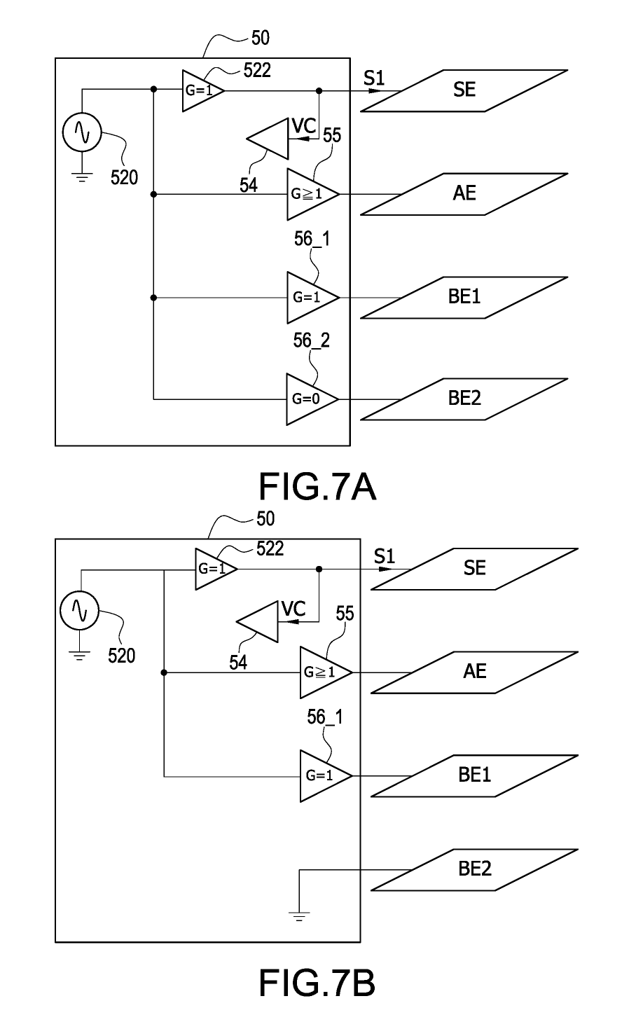

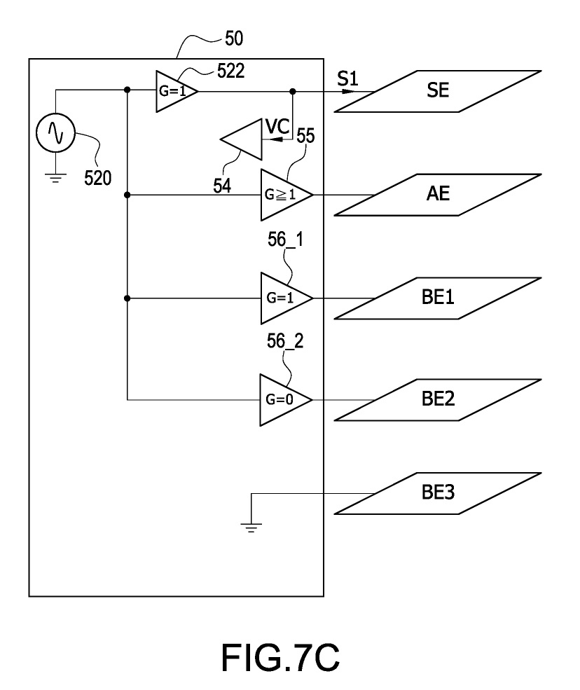

FIG. 7A shows signal generation for biometric identification apparatus 100 according to still another embodiment of the present invention. This embodiment is similar to that of FIG. 4A, however, the enhancing amplifier 55, the first blocking amplifier 56_1 and the second blocking amplifier 56_2 directly get input signals from the signal source 520 (namely, the inputs of the enhancing amplifier 55, the first blocking amplifier 56_1 and the second blocking amplifier 56_2 are directly connected to the signal source 520. Therefore, the enhancing amplifier 55, the first blocking amplifier 56_1 and the second blocking amplifier 56_2 can be prevented from interfering by the capacitance sensing signal VC from the sensing electrode SE. FIG. 7B shows signal generation for biometric identification apparatus 100 according to still another embodiment of the present invention. This embodiment is similar to that of FIG. 4B, however, the enhancing amplifier 55 and the first blocking amplifier 56_1 directly get input signals from the signal source 520 (namely, the inputs of the enhancing amplifier 55 and the first blocking amplifier 56_1 are directly connected to the signal source 520. Therefore, the enhancing amplifier 55 and the first blocking amplifier 56_1 can be prevented from interfering by the capacitance sensing signal VC from the sensing electrode SE. FIG. 7C shows signal generation for biometric identification apparatus 100 according to still another embodiment of the present invention. This embodiment is similar to that of FIG. 3B, however, the enhancing amplifier 55, the first blocking amplifier 56_1 and the second blocking amplifier 56_2 directly get input signals from the signal source 520 (namely, the inputs of the enhancing amplifier 55, the first blocking amplifier 56_1 and the second blocking amplifier 56_2 are directly connected to the signal source 520. Therefore, the enhancing amplifier 55, the first blocking amplifier 56_1 and the second blocking amplifier 56_2 can prevent from interfering by the capacitance sensing signal VC from the sensing electrode SE. Besides, in above embodiments shown in FIGS. 7A, 7B and 7C, the gain of the signal source 520 is, for example, 1.

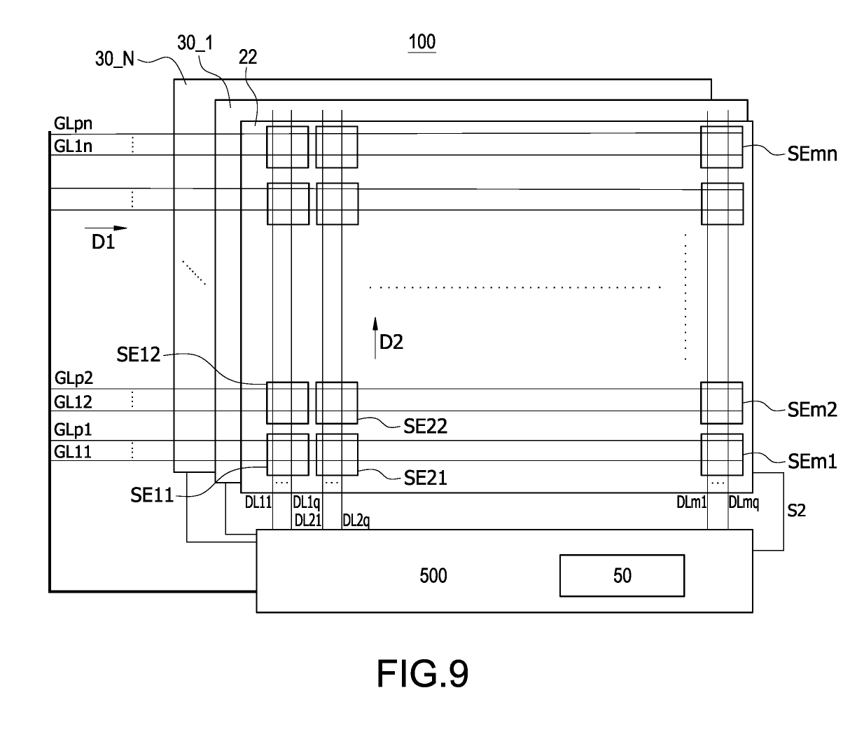

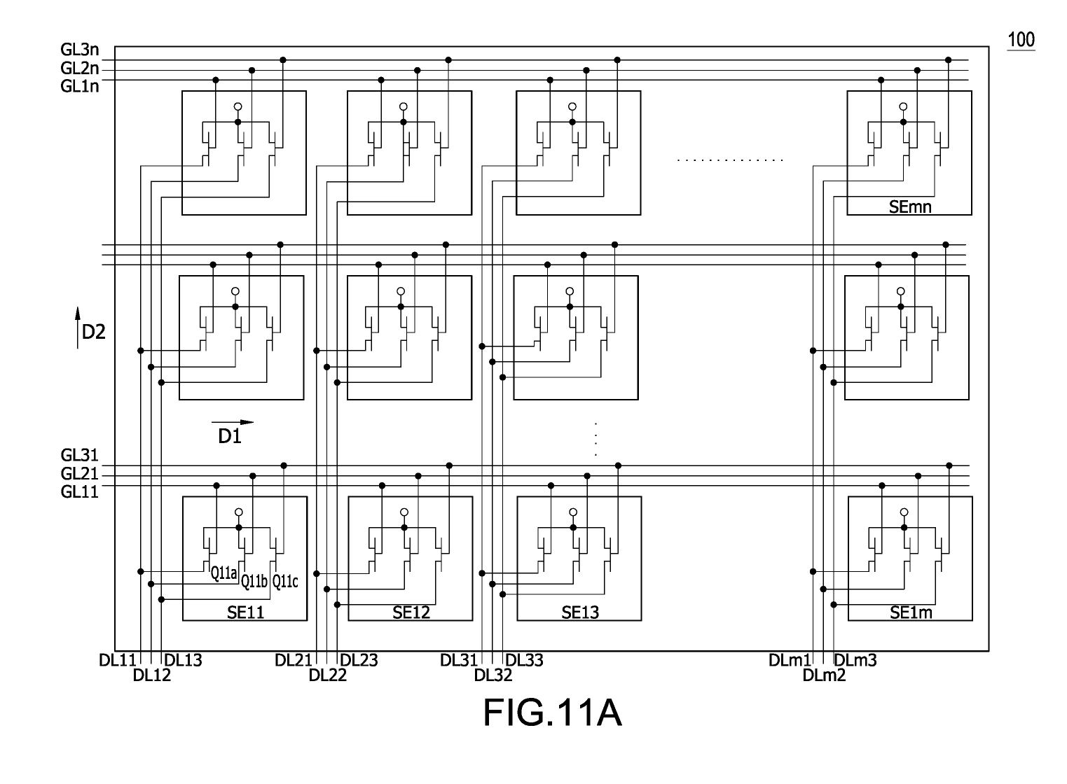

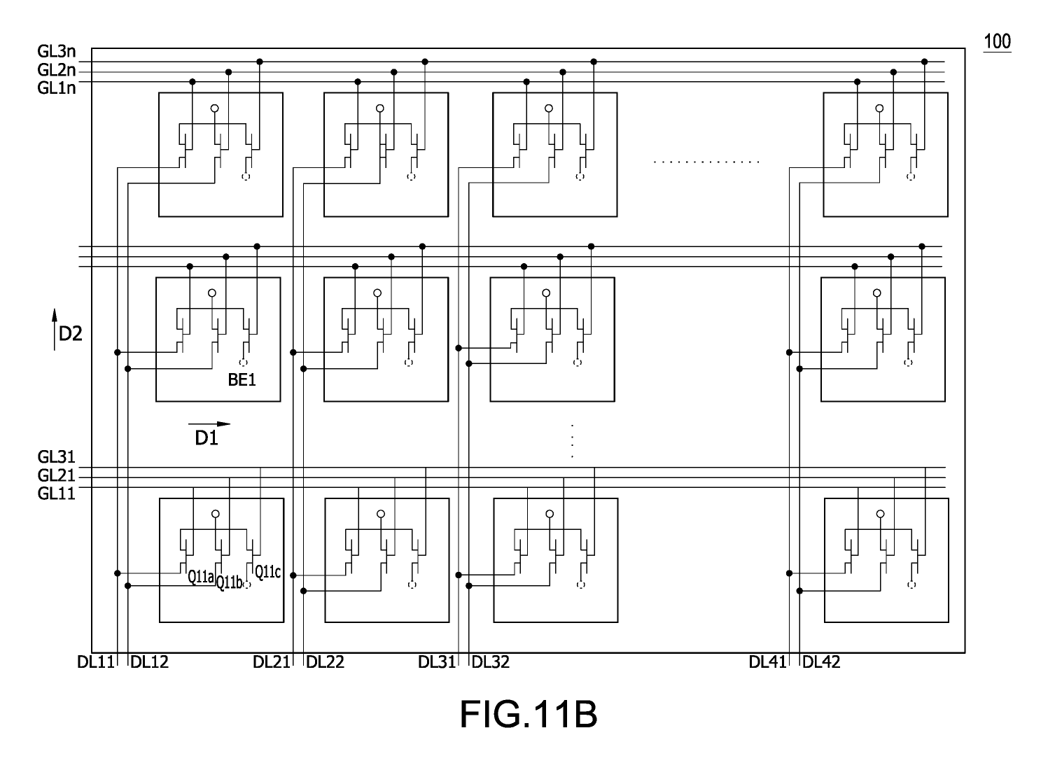

FIG. 9 is a detailed scheme diagram of the biometric identification apparatus 100 according to another embodiment of the present invention. With reference also to FIG. 11A, this figure shows the control signal and transistor switch for the biometric identification apparatus 100 according to another embodiment of the present invention. The embodiment shows in FIGS. 9 and 11A can be used for the embodiments shown in FIGS. 1C and 3B, however, the control signal can also be adapted to use for other embodiments in FIGS. 1A-7C. With reference to FIG. 9, the biometric identification apparatus 100 includes a sensing electrode layer 20 having a plurality of sensing electrodes SE11-SEmn, an enhancing electrode layer 22 having at least one enhancing electrode, a first capacitance-blocking electrode layer 30_1 having at least one capacitance-blocking electrode . . . an Nth capacitance-blocking electrode layer 30_N having at least one capacitance-blocking electrode. The biometric identification apparatus 100 further comprises a fingerprint sensing integrated circuit 500 having a self-capacitance sensing circuit 50. The fingerprint sensing integrated circuit 500 applies gate control signals through connection wires GL11 . . . GLpn along first direction D1 to nodes of corresponding transistor switches (with reference to FIG. 11A) and apples capacitance sensing related signals (such as the capacitance exciting signal S1, the enhancing signal S2 and the capacitance blocking signal) through connection wires DL11 . . . DLmq along second direction D2 to drain nodes of corresponding transistor switches (with reference to FIG. 11A).

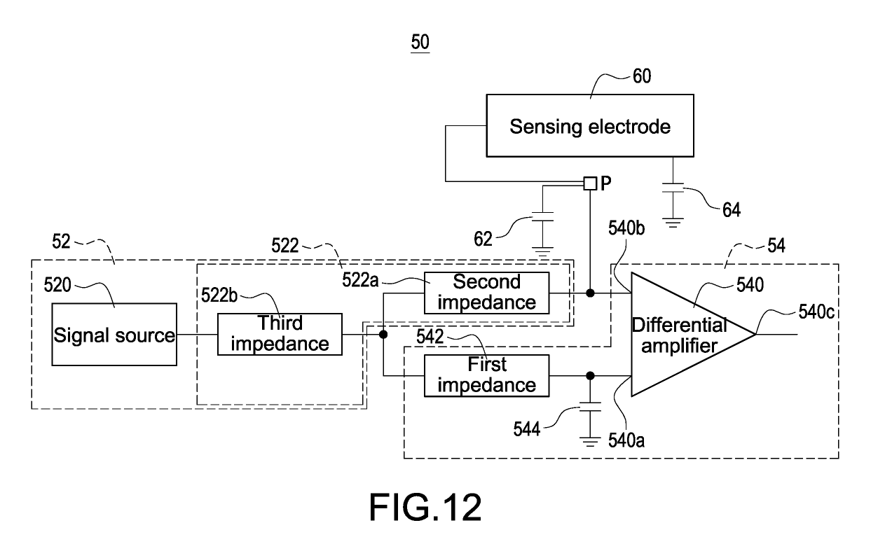

More particularly, the fingerprint sensing integrated circuit 500 determines which row of transistor switches are turned on by using the gate control signal sent through the connection wires GL11 . . . GLpn and determines which column of transistor switches will be applied with the capacitance exciting signal Si through selecting the connection wires DL11 . . . DLmq along second direction D2. Therefore, the fingerprint sensing integrated circuit 500 determines which of the corresponding sensing electrode (for example, the sensing electrode SE22 in FIG. 5A) will be applied with the capacitance exciting signal S1. Moreover, the fingerprint sensing integrated circuit 500 determines which column of transistor switches will be applied with the enhancing signal S2 through selecting other of the connection wires DL11 . . . DLmq along second direction D2. Therefore, the fingerprint sensing integrated circuit 500 determines which of the sensing electrodes (for example, the sensing electrode SE11 . . . SE13 and so on in FIG. 5A) will be applied with the enhancing signal S2. Simply put, by selecting specific row and specific column, at least one sensing electrode is selected and the capacitance exciting signal Si is applied to the selected sensing electrode. Moreover, the fingerprint sensing integrated circuit 500 also gets the capacitance sensing signal VC from the selected sensing electrode through the connection wire along the second direction D2 and then sends the capacitance sensing signal VC to the self-capacitance sensing circuit 50, thus sensing biometric feature of living beings (such as user) skin. Taking the sensing electrode SE11 in FIG. 11A as an example, the fingerprint sensing integrated circuit 500 applies the gate control signal to the corresponding transistor switch Q11a and the other transistor switches at the same row of the transistor switch Q11a through the connection wire GL11 along the first direction D1. Moreover, the fingerprint sensing integrated circuit 500 applies the capacitance exciting signal S1 to the drain of the transistor switch Q11a through the connection wire DL11 along the second direction D2. The transistor switch Q11a then applies the capacitance exciting signal S1 to the sensing electrode SE11 connected to the source of the transistor switch Q11a. Afterward, the fingerprint sensing integrated circuit 500 obtains the capacitance sensing signal VC from the sensing electrode SE11 and then sends the capacitance sensing signal VC to the self-capacitance sensing circuit 50 for sensing whether the self-capacitance sensing circuit 50 has corresponding capacitance variation. Moreover, the fingerprint sensing integrated circuit 500 applies the enhancing signal S2 through other of the connection wires (for example drain connection wire DL22) to enhance the measurement for the sensing electrode SE11. In other word, the fingerprint sensing integrated circuit 500 sequentially or randomly applies the capacitance exciting signal Si to at least one selected sensing electrode and then obtains the capacitance sensing signal VC from the selected sensing electrode, thus sensing biometric features of living beings skin. The detailed description for the self-capacitance sensing circuit 50 will be made with reference to FIG. 12 later.

FIG. 8 is a detailed scheme diagram of the biometric identification apparatus 100 according to still another embodiment of the present invention, this embodiment has further modification for the embodiment shown in FIG. 9. The biometric identification apparatus 100 shown in FIG. 8 further comprises a first shift register 710 (such as a p-bit TFT shift register). The fingerprint sensing integrated circuit 500 serially sends the gate input signals Gd1 . . . Gdp to the first shift register 710, where the gate input signals Gd1 . . . Gdp are corresponding to the gate control signals sent through the connection wires GL11 . . . GLpn along the first direction D1. The first shift register 710 parallel outputs the serially-input gate input signals Gd1 . . . Gdp to corresponding gate control signals sent through the connection wires GL11 GLpn along the first direction D1. By above-mentioned shift registering operation, the I/O pin count of the fingerprint sensing integrated circuit 500 can be greatly reduced.

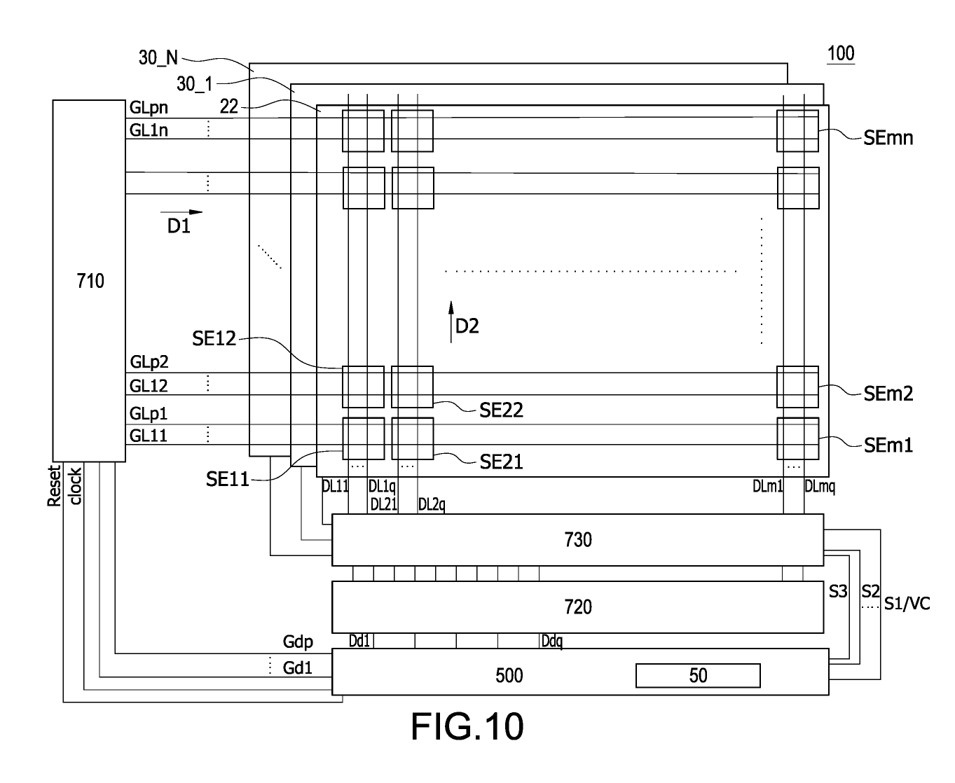

FIG. 10 is a detailed scheme diagram of the biometric identification apparatus 100 according to still another embodiment of the present invention, this embodiment has further modification for the embodiment shown in FIG. 8. The biometric identification apparatus 100 shown in FIG. 10 further comprises a second shift register 720 (such as a q-bit TFT shift register) and a multiplexer 730. Similarly, the fingerprint sensing integrated circuit 500 serially sends the gate input signals Gd1 . . . Gdp to the first shift register 710, where the gate input signals Gd1 . . . Gdp are corresponding to the gate control signals sent through the connection wires GL11 . . . GLpn along the first direction D1. The first shift register 710 parallel outputs the serially-input gate input signals Gd1 . . . Gdp to corresponding gate control signals sent through the connection wires GL11 . . . GLpn along the first direction D1. Besides, the fingerprint sensing integrated circuit 500 serially sends the multiplexing-selection control signals Dd1 . . . Ddq to the second shift register 720, and then the multiplexer 730 converts the capacitance sensing related signals (such as the capacitance exciting signal S1, the enhancing signal S2 and the capacitance blocking signal S3) into the drain signals applied through the connection wires DL11 . . . DLmq along the second direction D2 and applied to the corresponding transistor switches. By above mentioned architecture, the I/O pin count of the fingerprint sensing integrated circuit 500 can be greatly reduced. Besides, the multiplexer 730 sends the capacitance sensing signal VC from the corresponding transistor switch to the fingerprint sensing integrated circuit 500 for facilitating the self-capacitance sensing circuit 50 to sense self-capacitance change.

FIG. 11B shows the control signal and transistor switch for the biometric identification apparatus 100 according to another embodiment of the present invention. The embodiment shown in FIG. 11B is similar to that shown in FIG. 11A. However, in the biometric identification apparatus 100 shown in FIG. 11B, the first capacitance-blocking electrodes BE1, the second capacitance-blocking electrodes BE2 . . . or the Nth capacitance-blocking electrodes BEN can also be used as connection wires along the second direction D2. In FIG. 11B, the first capacitance-blocking electrodes BE1 are functioned also as connection wires along the second direction D2. Even though in the embodiments shown in FIGS. 11A and 11B, each of the sensing electrodes are used with three transistor switches, however, the sensing scheme of the present invention can also be implemented with two transistor switches. Therefore, the embodiments shown in FIGS. 11A and 11B are not limitation for the claim scope of the present invention. In the embodiments shown in FIGS. 8-10, the fingerprint sensing integrated circuit 500 can be bonded to, adhered to or soldered to the substrate 10 for mounting the sensing electrode layer 20. Alternatively, the fingerprint sensing integrated circuit 500 may be arranged on a flexible circuit board and electrically connected to the substrate 10 through the flexible circuit board.

FIG. 12 shows the circuit diagram of the self-capacitance sensing circuit 50 according to an embodiment of the present invention. The self-capacitance sensing circuit 50 mainly comprises a capacitance-excitation driving circuit 52 and a capacitance measuring circuit 54 to sense a capacitance change at the sensing point P. The capacitance-excitation driving circuit 52 comprises a signal source 520 and a driving unit 522 (including a second impedance 522a and a third impedance 522b). The capacitance measuring circuit 54 comprises a differential amplifier 540, a first impedance 542 and a first capacitor 544 and is used to sense a capacitance change at a sensing electrode 60, where the sensing electrode 60 comprises a first stray capacitance 62 and a second stray capacitance 64. The signal source 520 is electrically coupled with the first impedance 542 and the second impedance 522a. The first impedance 542 is electrically coupled with the first capacitor 544 and the first capacitor 544 is electrically coupled with the first input end 540a of the differential amplifier 540. The second impedance 522a is electrically coupled with the second input end 540b of the differential amplifier 540. The sensing electrode 60 is electrically coupled to the second impedance 522a and the second input end 540b through a node (such as an IC pin) of the self-capacitance sensing circuit 50. The first stray capacitance 62 is electrically coupled to the node and the second stray capacitance 64 is electrically coupled to the sensing electrode 60.

In the self-capacitance sensing circuit 50 shown in FIG. 12, the sensing electrode 60 receives a touch signal when a finger or a conductor is touched thereon. The signal source 520 is a periodical signal and sent to the third impedance 522, while the resistance values of the first impedance 542 and the second impedance 522a are identical. The differential amplifier 540 will generate a differential touch signal after receiving the signal source 520 and the touch signal from the sensing electrode 60. In this embodiment, the capacitance of the first capacitor 544 is equal to the resulting capacitance of the first stray capacitance 62 in parallel connection with the second stray capacitance 64. The capacitance of the second stray capacitance 64 changes when user finger approaches or touches the sensing electrode 60. Therefore, the voltages fed to the first input end 540a and the second input end 540b will be different such that the differential amplifier 540 has a (non-zero) differential output at the output end 540c. In this way, the minute capacitance change on the sensing electrode 60 can be detected by the differential amplifier 540. Moreover, the noise from circuits or power source can be advantageously removed. The detail of the self-capacitance sensing circuit 50 can be referred to U.S. Pat. No. 8,704,539 (corresponding to Taiwan patent No. 1473001) filed by the same applicant.

To sum up, by providing at least one enhancing electrode layer and at least one capacitance-blocking electrode layer, the electric field lines can be more focused toward user finger, the noise or interference from the ambient stray capacitance can be blocked or prevented to enhance the stability of sensed signal. Thus, particular embodiments have been described. Other embodiments are within the scope of the following claims. For example, the actions recited in the claims may be performed in a different order and still achieve desirable results.

What is claimed is:

1. A biometric identification apparatus having multiple electrode layers, comprising:
a substrate;
a sensing electrode layer having a plurality of sensing electrodes, the sensing electrode layer having a sensing face and an non-sensing face opposite to the sensing face;
an enhancing electrode layer arranged on one side of the non-sensing face of the sensing electrode layer and having at least one enhancing electrode;
N capacitance-blocking electrode layer arranged on one side of the enhancing electrode layer opposite to the sensing electrode layer, wherein N is a positive integer larger than or equal to one, each of the capacitance-blocking electrode layers has at least one capacitance-blocking electrode;
wherein the enhancing electrode is corresponding to at least one of the sensing electrodes, the capacitance-blocking electrode is corresponding to at least one of the sensing electrodes, wherein the substrate is arranged on one side of the sensing electrode layer or one side of the capacitance-blocking electrode layer.

2. The biometric identification apparatus of claim 1, further comprising a fingerprint sensing circuit, the fingerprint sensing circuit comprises at least one self-capacitance sensing circuit.

3. The biometric identification apparatus of claim 2, wherein the fingerprint sensing circuit is configured to sequentially or randomly apply a capacitance exciting signal to at least one selected sensing electrode, and obtain a capacitance sensing signal from the selected sensing electrode to sense biometric features of living beings skin.

4. The biometric identification apparatus of claim 3, wherein the fingerprint sensing circuit is configured to apply an enhancing signal with same phase as the capacitance exciting signal to at least one enhancing electrode corresponding to the selected sensing electrode.

5. The biometric identification apparatus of claim 4, wherein an amplitude of the enhancing signal is larger than or equal to an amplitude of the capacitance exciting signal.

6. The biometric identification apparatus of claim 3, wherein the fingerprint sensing circuit is configured to apply an enhancing signal with same phase as the capacitance exciting signal to the sensing electrodes surrounding the selected sensing electrode.

7. The biometric identification apparatus of claim 3, wherein the fingerprint sensing circuit is configured to apply a blocking signal with same phase as the capacitance exciting signal to at least one capacitance-blocking electrode corresponding to the selected sensing electrode.

8. The biometric identification apparatus of claim 3, wherein the fingerprint sensing circuit is configured to apply a zero voltage signal to at least one capacitance-blocking electrode corresponding to the selected sensing electrode.

9. The biometric identification apparatus of claim 2, wherein the substrate is an integrated circuit substrate and the fingerprint sensing circuit is fingerprint sensing integrated circuit arranged on the substrate.

10. The biometric identification apparatus of claim 1, wherein the substrate is a glass substrate, a sapphire substrate, a ceramic substrate or a metallic substrate.

11. The biometric identification apparatus of claim 10, further comprising an integrated circuit, wherein the integrated circuit is bonded to, adhered to or soldered to the substrate, or the integrated circuit is arranged on a flexible circuit board and electrically connected to the substrate through the flexible circuit board.

12. A biometric identification apparatus, comprising:
a substrate;
at least two electrode layer comprising a sensing electrode layer and an enhancing electrode layer, the sensing electrode layer having a sensing face on one side thereof and the enhancing electrode layer arranged on another side of the sensing electrode layer opposite to the sensing face, the sensing electrode layer having a plurality of sensing electrodes arranged in rows and columns, the enhancing electrode layer having a plurality of enhancing electrodes, each of the enhancing electrodes being corresponding to at least one of the sensing electrodes;
a plurality of transistor switches, each of the sensing electrodes being corresponding to and electrically connected to at least two transistor switches;
a plurality of connection wires comprising connection wires along a first direction and connection wires along a second direction, wherein each row of the sensing electrodes are corresponding to the connection wires along the first direction, and each of the connection wires along the first direction is connected to a node of the transistor switch corresponding to the row of the sensing electrodes; wherein each column of the sensing electrodes are corresponding to the connection wires along the second direction, and each of the connection wires along the second direction is connected to a node of the transistor switch corresponding to the column of the sensing electrodes.

13. The biometric identification apparatus of claim 12, further comprising: a first capacitance-blocking electrode corresponding to each of the sensing electrodes, the first capacitance-blocking electrode is arranged on one side of the enhancing electrode corresponding to the sensing electrode and opposite to the sensing electrode.

14. The biometric identification apparatus of claim 13, further comprising: a second capacitance-blocking electrode corresponding to each of the sensing electrodes, the second capacitance-blocking electrode is arranged on one side of the first capacitance-blocking electrode corresponding to the sensing electrode and opposite to the sensing electrode.

15. The biometric identification apparatus of claim 14, wherein the enhancing electrode, the first capacitance-blocking electrode, or the second capacitance-blocking electrode is configured to use as connection wire of the second direction.

16. The biometric identification apparatus of claim 12, further comprising: an integrated circuit, wherein the integrated circuit comprises at least one self-capacitance sensing circuit, the integrated circuit is configured to control which one of the connection wires along the second direction is electrically connected to each row of the sensing electrode through the connection wires along the first direction; wherein the integrated circuit is configured to apply capacitance-sensing related signals to the connection wires along the second direction corresponding to each row of sensing electrodes and obtain a capacitance sensing signal from the selected connection wires along the second direction, the integrated circuit is configured to send the capacitance sensing signal to the self-capacitance sensing circuit.

17. The biometric identification apparatus of claim 12, wherein the substrate is a glass substrate, a sapphire substrate, a ceramic substrate or a metallic substrate.

18. The biometric identification apparatus of claim 12, further comprising a first shift register arranged on the substrate and having output connected to connection wires of the first direction, the first shift register is configured to perform multi-bits shift register operation.

19. The biometric identification apparatus of claim 18, further comprising an integrated circuit, wherein the integrated circuit comprises at least one self-capacitance sensing circuit, the integrated circuit is connected to the connection wires of the second direction and the first shift register, the integrated circuit is configured to control through the first shift register to decide which one of the connection wires along the second direction is electrically connected to each row of the sensing electrode; wherein the integrated circuit is configured to apply capacitance-sensing related signals to the connection wires along the second direction corresponding to each row of sensing electrodes and obtain a capacitance sensing signal from the selected connection wires along the second direction, the integrated circuit is configured to send the capacitance sensing signal to the self-capacitance sensing circuit.

20. The biometric identification apparatus of claim 18, further comprising an integrated circuit, a second shift register arranged on the substrate and a multiplexer, wherein the integrated circuit comprises at least one self-capacitance sensing circuit, the integrated circuit is configured to control through the first shift register to decide which one of the connection wires along the second direction is electrically connected to each row of the sensing electrode; wherein the integrated circuit is configured to apply capacitance-sensing related signals to the connection wires along the second direction corresponding to each row of sensing electrodes through controlling the multiplexer with the second shift register, the integrated circuit obtain a capacitance sensing signal from the selected connection wires along the second direction, the integrated circuit is configured to send the capacitance sensing signal to the self-capacitance sensing circuit.
